(19) United States
(12) Patent Application Publication
(10) Pub. No.: US 2018/0322521 A1
(43) Pub. Date: Nov. 8, 2018

(54) AUTO EXTENSION OF DISCOUNT OFFER FOR ELECTRONIC TRANSACTION

(71) Applicant: Zycus Infotech Pvt.Ltd., Andheri East-Mumbai (IN)

(72) Inventors: Bikash Mohanty, Andheri East-Mumbai (IN); Neha Kale, Andheri East-Mumbai (IN)

(21) Appl. No.: 15/588,702

(22) Filed: May 8, 2017

(51) Int. Cl. G06Q 30/02; G06Q 30/04

(52) U.S. Cl. CPC G06Q 30/0235; G06Q 30/0215; G06Q 30/04

(57) ABSTRACT

The present invention describes an electronic system associated with financial transactions, particularly to offsetting of invoice/s obligations and methods utilized to complete those offsetting transactions such as select, schedule, purchase, fulfil, track and settle invoices using dynamic discounting using handheld device/s. The system provides a means to propose a discount offer for early payment to an electronic invoice and another means to accept or reject the discount offer. Further, an auto extension parameter for each of the said plurality of discount offer is provided. The system calculates the new discount offer pertaining to the invoice and provides a new auto populated discount offer to the invoice while accessing through web enabled input output devices selected from the group but not limited to mobile, iPhone, iPad, Android device, Windows device, Blackberry and the like.

### FIELD OF THE INVENTION

The present invention relates to electronic systems associated with financial transactions and the offsetting of invoice/s obligations. More particularly, it relates to a systems and method for offsetting the financial transactions such as select, scheduling, purchasing, fulfilling, tracking and settling invoices using dynamic discounting using handheld device/s. Still more particularly, it relates an automated feature of auto extension wherein the system itself offers a new discount if the old offered discount is not responded.

### BACKGROUND OF THE INVENTION

Enterprise resource planning (ERP) systems are used for managing the purchases of goods and services. Such systems may have databases of complex and extensive sets of information, such as addresses of various suppliers and other similar information related to purchasing. In addition, suppliers also use electronic accounting and record keeping systems which may assist in the receipt generation and tracking of the receipt of payment for goods and services.

In general, dynamic discounting describes a collection of methods in which payment terms can be established between a buyer and supplier to accelerate payment for goods or services in return for a reduced price or discount. Dynamic discounting methods are used for business to business transactions when contractual or pre-established early payment terms may not exist or the payment date does not conform to agree upon discount terms. Dynamic discounting includes the ability to agree upon terms that vary the discount according to the date of early payment. The earlier the payment, the greater the discount. In addition, it includes an ability for either buyer or supplier to propose an early payment date and discount for a one-time payment using electronic mail or specialized software. Through the use of dynamic discounting methods, buying organizations can increase the number and size of early payment discounts received and suppliers can get paid sooner at a lower cost of capital than alternative options.

Conventionally, the buying organization offers to pay their suppliers early in exchange for a discount. The earlier the payment, the greater the discount. Historically, it's not always been easy to achieve arrangements that work for both supplier and buyer and because of practical problems, it hasn't always been easy for buyers to actually pay early. But with the increased use of Purchase to Pay (P2P) technologies and methods buyer can pay promptly depending on the collaborative arrangements agreed upon with the supplier.

An example of benefits of dynamic discounting to buyers is as follows. If a buyer receives a 2 percent discount for early payment of an invoice, say paying a 30-day-net invoice after 10 days. Therefore, instead of earning interest on the cash held in an account, it is “invested” for 20 days to get a 2 percent return, this represents the equivalent of an over 36 percent annual return on capital. While the early payment of the invoice would lead to a reduction in interest on the cash, the return for early payment far outweighs the loss of interest. That early payment may also be very valuable to the supplier who values cash flow is more than high margins.

For many supplier's credit is difficult and/or expensive to secure. By working closely with customers and leveraging the power and flexibility of a P2P system, they can create a genuine synergy that reduces prices, cost of borrowing and ultimately the cost of doing business.

Prior systems require considerable amount of effort to update and maintain, and may lack compatibility with the systems used by parties with whom an organization wishes to engage in transactions. There is thus a need for improved systems to facilitate transactions between buyers and supplier.

Based on the current process of issuing and paying invoices whether on paper or electronically, between suppliers and customers, it would be economically helpful and desirable to produce a new system and related methods for matching a supplier's invoices and offsetting its purchase invoices with its sales invoices by linking its invoices with those of its customers and its suppliers (vendors) and their customers and suppliers in order to offset invoice debit and credit values, to reduce payment times, to reduce the number of outstanding invoices, to reduce invoice discount costs, penalties, interest, and the need to borrow or finance assets, to increase buying power or a combination thereof.

### SUMMARY OF THE INVENTION

It is therefore, an object of the present invention to provide an electronic system associated with financial transactions, particularly to offsetting of invoice/s obligations.

It is a further object of the present invention to provide a system and method to complete the offsetting transactions related to select, schedule, purchase, fulfil, track and settle invoices using dynamic discounting using handheld device/s.

It is a further object of the present invention to provide a system having an automated feature of auto extension wherein the system itself offers a new discount if the old offered discount is not responded.

It is a further object of the present invention for the new discount offer for the new period is auto generated by the system based on one or combination of procurement criteria decision rules.

Accordingly, the present invention describes a system and method to propose a discount offer for early payment to an electronic invoice. Further, the system comprises of means to accept or reject the said discount offer to that electronic invoice. A dynamic discounting system is provided pertaining to the discounting of electronic invoice to define auto extension parameter for each of the said plurality of discount offer, requesting the user to select at least one of the electronic invoice auto extension parameter modules. The user decides between at least one of the electronic invoice discounting parameter module or combination of them, for providing discount offer. The said system calculates the new discount offer pertaining to the invoice and provides a new auto populated discount offer to the invoice while accessing through a web enabled input output devices selected from the group but not limited to mobile, iPhone, iPad, Android device, Windows device, Blackberry and the like.

These and other objects and advantages of the present invention will become apparent from a reading of the following specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Present invention relates to electronic systems associated with financial transactions, particularly to offsetting of invoice/s obligations and the systems and methods utilized to complete those offsetting transactions. It related to a method and system to select, schedule, purchase, fulfil, track and settle invoices using dynamic discounting using web enabled handheld device/s.

In accordance to the present embodiment of the present invention, describes a method of dynamic discounting between a buyer and a supplier. It has been known that, when a discount offer is made either by supplier or buyer, either it is accepted, or rejected, or countered, or else it remains idle awaiting for response. However, if the said discount remains idle awaiting for response and if no response is provided then the user has to monitor manually that the offer does not get expired. The user has to rework the discount manually and provide a new discount offer into the system. Therefore, the present invention provides an automated feature of auto extension wherein the system itself offers a new discount if the old offered discount is not responded. The new discount offer for the new time period is auto generated by the system based on one or combination of procurement criteria decision rules.

In accordance with one of the embodiment of the present invention, describes a system and method to propose a discount offer for early payment to an electronic invoice. Further, the system comprises of means to accept or reject the said discount offer to that electronic invoice. A dynamic discounting system is provided pertaining to the discounting of electronic invoice to define auto extension parameter for each of the said plurality of discount offer, requesting the user to select at least one of the electronic invoice auto extension parameter module. The user decides between at least one of the electronic invoice discounting parameter module or combination of them, for providing discount offer. The said system calculates the new discount offer pertaining to the invoice and provides a new auto populated discount offer to the invoice while accessing through a web enabled input output devices selected from the group but not limited to mobile, iPhone, iPad, Android device, Windows device, Blackberry and the like.

In accordance with one of the embodiment of the present invention, describes a system enabled method based on procurement criteria and decision rules provided. The said decision rules include supplier parameters for e.g. small suppliers, credit ratings, supplier revenue, geography, payment terms and the like. Further, the invoice parameters include invoice value, invoice date, invoice due date, discounts and invoice status and credit period. Pertaining to the decisions rules, if the discount offer is not accepted then the system based on decision rule checks for the supplier parameter. If the supplier parameter is for a small, then the said system checks for the invoice value which if greater than X″ amount the said system further check for any credit period available. If credit period is available, the said system checks for the pending credit period and if it is greater than 10 days and then the said system checks for credit rating if it is less then provides further offer of 5% more discount for additional 10 more days.

In accordance with one of the embodiment of the present invention, the suppliers are divided in buckets characterized by parameters such as credit ratings, supplier revenue, geography, and payment terms and further more such parameters that appears to be relevant to the said context. Each bucket will then be given a dynamic discounting rate, which will be communicated to the supplier. These parameters will be fetched from the supplier database as well as from ERP. Thus, the categorical classification enables to build the said system wherein a buying organization as per their policy may prefer small supplier for selection. The supplier having the small supplier status may be a consideration when the suppliers are selected for the discounting program, for example, a small supplier in US is defined as a supplier whose worldwide annual GST/HST taxable supplies, including zero-rated supplies and including the supplies (sales) of all associates, are less than $30,000, or less than $50,000 for public service bodies (colleges, non-profit organizations, charities, hospitals). For smaller suppliers, different discount percentage shall be configured.

Further the credit rating of the supplier based on his credit history may be directly taken up from third party database. The supplier who is in more need of money would take up discounting offers more often rather than the supplier having surplus cash flow. Supplier I buyer having good credit ratings will be chosen for different slab of discount.

In terms of supplier revenue, a Supplier Company which is big in terms of revenue would may not be in need of immediate cash in exchange of discounts. The probability of the supplier taking up the discounting offer is a function of the Supplier company revenue. Based on buyer supplier revenue different slab of discount shall be offered.

Pertaining to the geography, based on the buying organization policy they may prefer suppliers from selected geography for offering dynamic discounts. Hence the said information about the supplier may be important for deciding whether the said supplier is to be considered for the discounting program or not. Based on different geographical region as to where supplier or buyer is based different discount will be offered. When it comes to payment terms, the payment terms mutually decided and accepted between the buying organization and the supplier may be one more such criteria for the buyer to choose a particular supplier for discounting program.

In accordance with one of the embodiment of the present invention, an invoice criterion are provided which the buyer as well as the supplier to decide which invoices (Pending for Payment) should be chosen for early payment. Based on the above parameters, once the supplier has been shortlisted as a potential candidate for the dynamic discounting, all the “ready to Pay” invoices can be analysed for selection of offer to pay early on the decided rate. When the supplier proposes a program, it will be suggested a combination of invoices that best satisfy his cash needs while keeping the discounts to minimum, however, when the buyer proposes a program, the system will suggest a combination of invoices that can be paid in the given budget by maximizing the discount opportunities. Thus, the supplier and the buyer can choose to apply early payments to single invoices by selecting the options “Pay Me Early” (for the Supplier) and “Early Pay Offer” (for the Buyer) in the invoice listing and said list is filtered based on the invoice parameters of invoice value, invoice date, invoice due date and discount parameters.

The invoicing parameters are defined wherein the invoice value is the net amount of the invoice which may be a factor in selecting the invoice. The invoice date is the date on which the said invoice was created/submitted and may be considered as a criterion for selection. E.g.: A buying organization may follow FIFO—first in first out strategy (giving the earliest received invoices preference for selection), the invoice due date is the date on which the invoice is due for payment would be considered for the selection. Invoices due on a later date mean more discounts than those which are due on an earlier date, the discount is the amount that would be offered based on the value of invoice and the discounting percent to be applied can be considered for selection of the invoices. The invoice status is the status for the invoices to be considered for dynamic discounting that will always be ready to be paid’.

Thus, according to one of the embodiment of the present invention, the system and method provided comprising of means to propose a discount offer for early payment to an electronic invoice. It further comprising of means to accept or reject the discount offer to that electronic invoice whereby a business transaction methodology is provided wherein, a dynamic discounting system is provided pertaining to the discounting of electronic invoice to define auto extension parameter for each of said plurality of discount offer, asking the user to select at least one of the electronic invoice auto extension parameter module, user deciding between at least one of the electronic invoice discounting parameter module or combination of them, for providing discount offer, by maximizing the discount opportunities. Thus, the supplier and the buyer can choose to apply the said system can populate discount offer to the invoice while accessing through web enabled input output devices selected from the group but not limited to mobile, iPhone, iPad, Android device, Windows device, Blackberry and the like. Therefore, a buyer and supplier utilizes respective handheld devices for facilitating said transaction. A method of transaction wherein for sending early payment request, enables buyer to select the invoice they are willing to pay early from the invoice listing card on the handheld device, after the said buyer has to selects option/application on it to open the invoice option. Further the buyer has to select ‘Early Pay’ to send an early payment request and a new window opens where the user is able to send the request after adding comments and sending. The discount offer to be sent is displayed on the said window so that the buyer can confirm it before clicking on the submit button. System enables auto extension with new discount offer in scenario wherein there is Accepting/Rejecting/Negotiate a dynamic discounting request. However, if there is no acceptance or rejection and the offer gets expired then that status will trigger the system to generate a new offer based on the above-mentioned decision rules to gets reflected on supplier and buyer side.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A dynamic discounting system for auto extension of discount offer for an electronic invoice accessing through web enabled handheld input output devices comprising the steps of:
i. defining an auto extension parameter for each of plurality of discount offer;
ii. prompting the user to select at least one of the electronic invoice auto extension parameter module;
iii. user deciding between at least one of the electronic invoice discounting parameter module or combination of them;
iv. calculating the new discount offer to said invoice and providing a new auto populated discount offer to the invoice.

2. The dynamic discounting system for auto extension of discount offer in claim 1 wherein, the said parameters are selected from supplier parameters but not limiting to small suppliers, credit ratings, supplier revenue, geography, payment terms and the like; or the invoice parameters such as invoice value, invoice date, invoice due date, discounts and invoice status and credit period.

3. The dynamic discounting system for auto extension of discount offer in claim 1 wherein, the suppliers are divided into buckets characterized by parameters such as credit rating, supplier revenue, geography, and payment terms.

4. The dynamic discounting system for auto extension of discount offer in claim 1 wherein, the said system is a web enabled handheld device/s selected from but not limited to mobile, iPhone, iPad, Android device, Windows device, Blackberry.
